(19) United States
(12) Patent Application Publication
(10) Pub. No.: US 2017/0331098 A1
(43) Pub. Date: Nov. 16, 2017

(54) Verbindungselement, Kontaktierungssystem und Batteriemodul sowie Verfahren zur Herstellung derselben

(71) Applicant: Robert Bosch GmbH, Stuttgart (DE)

(72) Inventors: Claus Gerald Pflueger, Markroningen (DE); Matthias Oechsle, Ditzingen-Hirschlanden (DE); Klaus Wipfler, Niefern-Oeschelbronn (DE)

(21) Appl. No.: 15/153,971

(22) Filed: May 13, 2016

(51) Int. Cl. H01M 2/22; H01M 10/48; H01M 2/20

(52) U.S. Cl. CPC H01M 2/22; H01M 2/202; H01M 10/48

(57) ABSTRACT

The invention relates to a connecting element of a battery module or of a contacting system for a battery module, realized to connect a cell connector, designed for electrically conductive connection of voltage taps of two battery cells of the battery module, or a voltage tap of a battery cell of the battery module, to at least one conductor of a signal line of a monitoring system of the battery module in an electrically conductive manner, the connecting element having a first connection region, which is realized for materially bonded connection to the cell connector or to the voltage tap, and the connecting element furthermore having a second connection region, which is realized to accommodate at least one conductor of the signal line of the monitoring system of the battery module in a force-fitting and/or form-fitting manner.

### BACKGROUND OF THE INVENTION

The invention is based on a connecting element according to the generic type. The present invention also provides a contacting system and a battery module having such a contacting element, and a method for producing the same.

It is known from the prior art that batteries that are used, in particular, as drive batteries in hybrid, plug-in hybrid and electric vehicles, such as, for example, lithium-ion batteries, may have a modular structure, i.e. may consist of a plurality of battery modules. Furthermore, a battery module preferably has a multiplicity of individual battery cells, which are interconnected to form the battery module, the individual battery cells being able to be interconnected in series or in parallel. In this case the voltage taps of the individual battery cells, such as, in particular, lithium-ion battery cells, lithium-polymer battery cells or lead acid accumulators, are connected to each other in an electrically conductive manner by means of so-called cell connectors. A battery usually has a monitoring system for monitoring the functioning and safety of the individual battery cells. The voltage taps of the battery cells or the cell connectors in this case are connected to the monitoring system in an electrically conductive manner by means of a signal line.

It is known from the prior art, for example from GM 79 33 001, that a connecting terminal is used to produce a connection between a battery pole and an electrical supply cable. In this case the connecting terminal is connected to the battery pole by means of a screwed connection, and accommodates the supply cable.

### SUMMARY OF THE INVENTION

The connecting element of a battery module or of a contacting system according to the invention has the advantage that at least one conductor of a signal line of a monitoring system of the battery module can be reliably connected in an electrically conductive manner to a cell connector or to a voltage tap. In this case, connection processes that can be performed independently of one another, and that are therefore not mutually influencing, are possible because of the separate arrangement of a first connection region, realized for materially bonded connection to the cell connector or to the voltage tap, and of a second connection region, realized to accommodate the at last one conductor of the signal line in a force-fitting and/or form-fitting manner. Furthermore, this also makes it possible to evaluate, in particular according to defined standards, the materially bonded connection of the first connection to the cell connector or to the voltage tap, independently of the force-fitting and/or form-fitting accommodation of the at least one conductor of the signal line by the second connection region. This additionally offers the advantage of being able to determine unambiguously, in the case of defective batteries resulting from the failure of the connection between the signal line and the cell connector or the voltage tap, whether the materially bonded connection or the force-fitting and/or form-fitting accommodation has failed.

According to the invention, a connecting element of a battery module or of a contacting system for a battery module is provided. The connecting element in this case may be realized to connect a cell connector to at least one conductor of a signal line of a monitoring system of the battery module in an electrically conductive manner. The cell connector in this case is designed for electrically conductive connection of voltage taps of two battery cells of the battery module. Furthermore, the connecting element may also be realized to connect a voltage tap of a battery cell of the battery module to at least one conductor of a signal line of a monitoring system of the battery module in an electrically conductive manner. For this purpose the connecting element has a first connection region, which is realized for materially bonded connection to the cell connector or to the voltage tap. Furthermore, the connecting element has a second connection region, which is realized to accommodate at least one conductor of the signal line of the monitoring system of the battery module in a force-fitting and/or form-fitting manner.

Advantageous developments and enhancements of the device specified in the independent claim, or of the method specified in the independent claim, are rendered possible by the measures stated in the dependent claims.

In particular, a signal line of the monitoring system of the battery module is to be understood here to mean an electrical line having at least one conductor that is made of an electrically conductive material and that is preferably surrounded, at least partially, by an electrical insulation. In this case, to enable an electrically conductive connection to be produced, the portion of the signal line of which at least one conductor is to be accommodated by the second connection region in force-fitting and/or form-fitting manner preferably does not have any electrical insulation. Advantageously, a signal line has a plurality of conductors, such that, in the event of a mechanical breakage of a conductor, for example caused by an unfavorable cable routing or by stress during operation, the functioning of the signal line can continue to be maintained by undamaged conductors. In particular, in this case, for example, a signal line having seven conductors meets the requirements in respect of functional reliability with, at the same time, reasonable cost.

A voltage tap is to be understood to mean an element of a battery cell that enables the voltage produced by the battery cell to be tapped. In particular, the voltage tap is connected in an electrically conductive manner to the anode or the cathode of the battery cell. Clearly, the anode or the cathode may preferably constitute the voltage tap.

It is advantageous if the connecting element is made of an electrically conductive material. In this case, the electrically conductive material may be, in particular, copper, aluminum or nickel. Furthermore, it is also advantageous if the connecting element comprises at least one electrically conductive material, such that the first connection region and the second connection region are connected to each other in an electrically conductive manner. Preferably, the connecting element, in particular the first connection region and/or the second connection region, may also have a coating of an electrically conductive material such as, in particular, copper, aluminum or nickel. As a result, the first connection region, which is designed, in particular, for electrically conductive connection to the cell connector or to the voltage tap, and the second connection region, which is designed, in particular, for electrically conductive connection to the at least one conductor of a signal line, are also connected to each other in an electrically conductive manner. The connecting element thus renders possible an electrically conductive connection between the cell connector or the voltage tap and the at least one conductor of the signal line, thereby enabling the monitoring unit of the battery module to be connected in an electrically conductive manner to the cell connector or the voltage tap, for example for the purpose of monitoring the temperature or the voltage of a battery cell of the battery module.

It is expedient if the first connection region is connectable to the cell connector or to the voltage tap by welding, in particular by ultrasonic welding. A reliable connection can thereby be produced between the first connection region of the connecting element and the cell connector or the voltage tap. In this case, this connection, as already described further above, may be produced according to defined criteria during manufacture, independently of the force-fitting and/or form-fitting accommodation of the at least one conductor of the signal line, and can also be evaluated again according to these criteria, in particular in after-series supply. Furthermore, the first connection region may also be connectable to the cell connector or to the voltage tap by soldering or by adhesive bonding.

Furthermore, it is also expedient if the second connection region is deformable for the purpose of accommodating the at least one conductor of the signal line in a force-fitting and/or form-fitting manner. In this case, the accommodation of the at least one conductor of the signal line by the second connection region may be realized, in particular, by crimping. Also in this case, owing to the separation of the second connection region from the first connection region, the force-fitting and/or form-fitting accommodation can be produced according to defined criteria and, in particular, also evaluated again according to the latter, independently of the materially bonded connection of the first connection region to the connecting element and the voltage tap.

Force-fitting connections in this case are to be understood to mean those connections in which the forces applied to the at least one conductor by the second connection region effect a sufficient adhesive force between the second connection region and the at least one conductor, such that the connection does not become undone. In particular, a crimp connection or, also, a screwed connection may constitute such a force-fitting connection. The applied force may also, at the same time, provide for the electrically conductive contact.

Form-fitting connections in this case are to be understood to mean those connections in which the second connection region and the at least one conductor engage mechanically in each other in such a manner that their shape prevents the connection from becoming undone. The mutual engagement in this case may also, at the same time, provide for the electrically conductive contact.

It is furthermore advantageous in this case that the second connection region has at least one deformation region made of a metallic material. In this case, the deformation region is irreversibly deformable, for the purpose of accommodating the at least one conductor of the signal line, such that the deformation region surrounds the at least one conductor in an at least partially contacting manner. This enables an electrically conductive connection to be produced between the second connection region, in particular the deformation region of the second connection region, and the at least one conductor of the signal line, the irreversible deformation of the deformation region providing for reliable accommodation over the service life of the battery module. Irreversibly deformable in this context is to be understood to mean that the deformation region retains its shape after having been deformed to accommodate the at least one conductor.

The invention additionally relates to a contacting system for a battery module. The battery module in this case comprises a plurality of battery cells, which each have at least one voltage tap. The contacting system in this case has at least one cell connector, which is designed to connect the voltage taps of two battery cells of the battery module in an electrically conductive manner. The contacting system in this case may be designed to interconnect the battery cells serially to each other, a cell connector being designed to connect a positive voltage tap of a battery cell to a negative voltage tap of an adjacent battery cell in an electrically conductive manner. Furthermore, the contacting system may also be designed to interconnect the battery cells in parallel to each other, a cell connector being designed to connect positive and negative voltage taps, respectively, of two battery cells or, preferably, also of a plurality of battery cells, to each other in an electrically conductive manner. Furthermore, the contacting system has at least one signal line, which has at least one conductor. The signal line is designed to connect the cell connector, or the voltage tap, to a monitoring system in an electrically conductive manner. In this case, the at least one cell connector and the at least one signal line are disposed on a support element. In particular, the at least one cell connector and the at least one signal line are connected to the support element. Furthermore, the contacting system has a connecting element according to the invention, described above.

The contacting system, according to the invention, for a battery module serves to connect the plurality of battery cells of the battery module to each other in an electrically conductive manner by means of the cell connectors of the contacting system. Preferably, the battery cells are disposed in a battery module housing, and the contacting system, in particular the support element of the contacting system, may be connected to the battery cells, or to the battery module housing, in such a manner that the cell connectors each connect the voltage taps of two battery cells to each other in an electrically conductive manner. This has the advantage that the electrically conductive connection between the cell connector and the signal line of the monitoring system can be effected before the electrically conductive connection of the voltage taps of two battery cells is produced, in particular in an upstream production step.

It is advantageous in this case if the connecting element according to the invention connects the cell connector and the at least one conductor of the signal line to each other in an electrically conductive manner. For this purpose, the first connection region of the connecting element is connected to the cell connector in a materially bonded manner. Furthermore, the second connection region accommodates the at least one conductor in a force-fitting and/or form-fitting manner. It is thus possible for all electrically conductive connections necessary for monitoring the battery cells to be realized before the contacting system is fitted. At this point, it is to be expressly pointed out that the electrically conductive connection between the cell connector and the voltage tap can be produced when the contacting system has been connected to the battery module.

The invention also relates to a method for producing a contacting system. In this case, in a first step, a connecting element according to the invention is provided. Then, in a second step, at least one cell connector is positioned on a support element. Furthermore, in the second step, at least one signal line is positioned on the support element. In particular, in the second step, the at least one cell connector and the at least one signal line are connected to the support element of the contacting system. Furthermore, in a third step, the connecting element according to the invention is then positioned on the support element. At this point, it is to be expressly pointed out that the time sequence of the positioning of the at least one cell connector, the at least one signal line and the connecting element according to the invention is not intended to be fixed.

It is furthermore expedient if, in the third step, the first connection region is connected to the cell connector in a materially bonded manner. It is furthermore also expedient if, in the third step, at least one conductor of the at least one signal line is accommodated by the second connection region. This has the advantage, as already described further above, that the electrically conductive connections required for the monitoring system are already realized before the contacting system is connected to the battery cells of the battery module.

In addition, the invention also relates to a method for producing a battery module. In this case, in a first step, a connecting element according to the invention is provided. Then, in a second step, the voltage taps of two battery cells are connected to each other in an electrically conductive manner by means of at least one cell connector. Furthermore, in the second step, a signal line that can be connected to a monitoring unit is provided. Then, in a third step, the first connection region may be connected to the cell connector in a materially bonded manner. Furthermore, in the third step, the at least one conductor of the at least one signal line may be accommodated by the second connection portion. This has the advantage that the materially bonded connection of the first connection region to the cell connector, and the force-fitting and/or form-fitting accommodation of the at least one conductor of the at least one signal line by the second connection region can be produced, and also evaluated, according to defined standards, independently of each other in each case.

Furthermore, the invention also relates to a battery module having a contacting system according to the invention, at least one cell connector connecting the voltage taps of two battery cells in an electrically conductive manner. The contacting system in this case may preferably be produced by a method according to the invention.

Furthermore, the invention also relates to a battery module having a connecting element according to the invention. The battery module in this case may preferably have been produced by a method according to the invention.

### BRIEF DESCRIPTION OF THE DRAWINGS

Exemplary embodiments of the invention are represented in the drawings and explained in greater detail in the description that follows.

FIG. 1 is a schematic top view of a connecting element according to the invention that connects at least one conductor of a signal line to a cell connector or to a voltage tap in an electrically conductive manner,

FIG. 2a is a cross section, along line A-A shown in FIG. 1, of a second connection region that accommodates at least one conductor of a signal line in a force-fitting manner,

FIG. 2b is a cross section similar to FIG. 2a of a second connection region before accommodating at least one conductor of a signal line,

FIG. 3 is a schematic side view of a battery module having a connecting element according to the invention, and

FIG. 4 is a top view of a battery module having a contacting system according to the invention.

### DETAILED DESCRIPTION

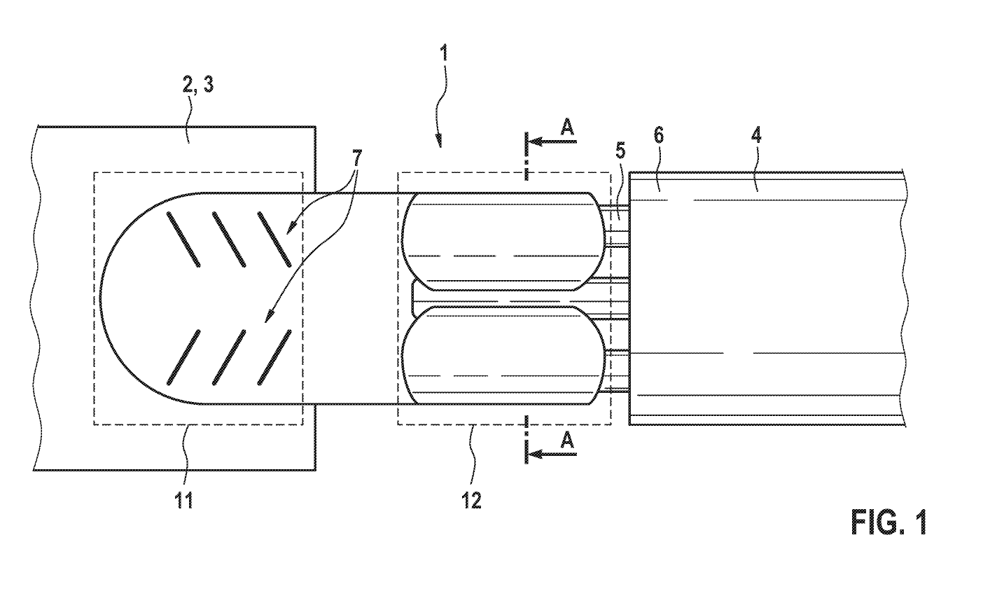

FIG. 1 shows a schematic top view of a connecting element 1 of a battery module 8 or of a contacting system 13 for a battery module 8, which connecting element connects at least one conductor 5 of a signal line 4 to a cell connector 2 and/or to a voltage tap 3 in an electrically conductive manner.

A portion of a cell connector 2 or of a voltage tap 3 of a battery cell 9 can be seen in FIG. 1. Furthermore, FIG. 1 also shows a signal line 4 of a monitoring system, not shown in FIG. 1, of the battery module 8. The signal line 4 has a plurality of conductors 5. Furthermore, the plurality of conductors 5 is surrounded, at least partially, by an electrical insulation 6, in order to prevent unwanted current flows.

The connecting element 1 has a first connection region 11 and a second connection region 12, each respectively indicated by the boxes drawn in broken lines. The first connection region 11 in this case is realized for materially bonded connection to the cell connector 2 or to the voltage tap 3. Furthermore, the second connection region 12 is realized to accommodate at least one conductor 5 of the signal line 4 of the monitoring system of the battery module in a force-fitting and/or form-fitting manner.

FIG. 1 shows that the first connection region 11 is materially connected to the cell connector 2, or to the voltage tap 3. In this case, the first connection region 11 is connected by welding to the cell connector 2, or to the voltage tap 3, indicted by the exemplarily drawn weld points 7. As a result of the materially bonded connection of the first connection region 11 to the cell connector 2 or to the voltage tap 3, the first connection region 11 is connected to the cell connector 2, or to the voltage tap 3, in an electrically conductive manner.

Furthermore, FIG. 1 also shows that the second connection region 12 accommodates the plurality of conductors 5 of the signal line 4 in a force-fitting manner. As a result of the plurality of conductors 5 being accommodated by the second connection region 12 in a force-fitting manner, the second connection region 12 is connected to the plurality of conductors 5 in an electrically conductive manner.

In addition, the connecting element 1 is made of an electrically conductive material, or the first connection region 11 and the second connection region 12 are connected to each other in an electrically conductive manner by an electrically conductive material.

The connecting element 1 shown in FIG. 1 thus connects the plurality of conductors 5 of the signal line 4 to the cell connector 2 or to the voltage tap 3 in an electrically conductive manner. In this case, the first connection region 11 and the second connection region 12 are disposed separately from each other, such that it is possible for the first connection region 11 to be connected to the cell connector 2 or to the voltage tap 3 independently of the connection of the second connection region 12 in the plurality of conductors 5 of the signal line 4.

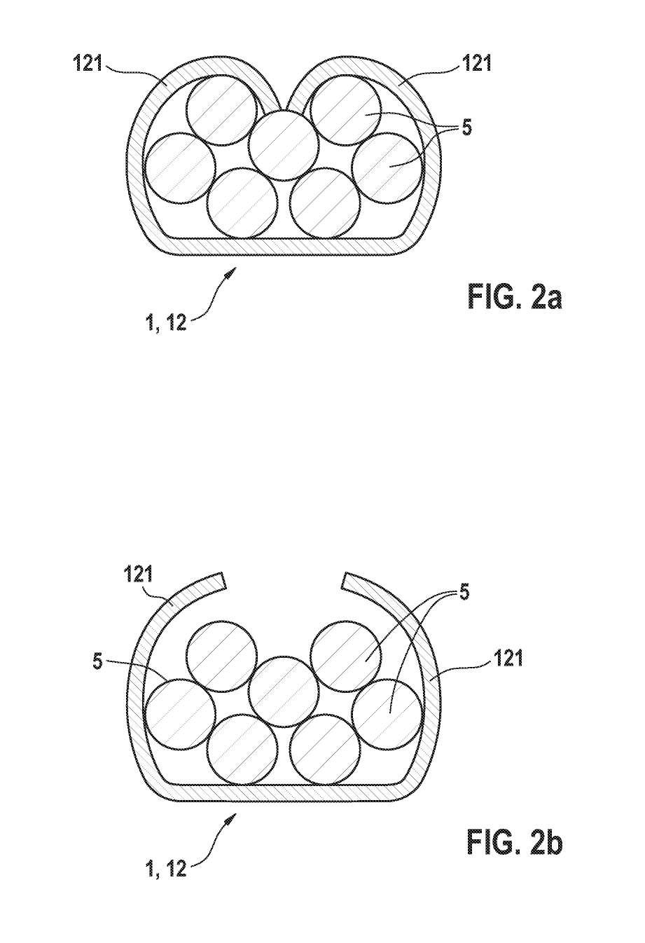

FIG. 2a shows a cross section through the second connection region 12 according to the section A-A shown in FIG. 1. In this case the second connection region 12 accommodates a plurality of conductors 5 of the signal line 4 in a force-fitting manner.

FIG. 2b shows a cross section through the second connection region 12. Unlike FIG. 2a, the plurality of conductors 5 of the signal line 4 have not yet been received in a force-fitting manner by the second connection region 12.

Furthermore, the second connection region 12 has at least one deformation region 121, which can be deformed for the purpose of accommodating the conductors 5 of the signal line 4. Preferably, the deformation region 121 is made of a metallic material. Furthermore, preferably, the deformation region 121 is irreversibly deformable for the purpose of accommodating the at least one conductor 5 of the signal line 4, such that the deformation region 121 surrounds the at least one conductor, in an at least partially contacting manner. FIG. 2b thus shows a deformation region 121 that is not yet completely irreversibly deformed, whereas FIG. 2a shows an irreversibly deformed deformation region 121. In this case, the deformation region 121 shown in FIG. 2a surrounds the plurality of conductors 5, at least partially, and also effects contacting of the latter. Since the deformation region 121 and the conductors 5 of the signal line 4 are preferably made of a metallic material, an electrically conductive connection can thus be produced.

In particular, the connection of the second connection region 12 to conductors 5 of the signal line 4 is realized as a crimp connection, which can therefore be evaluated according to a standard.

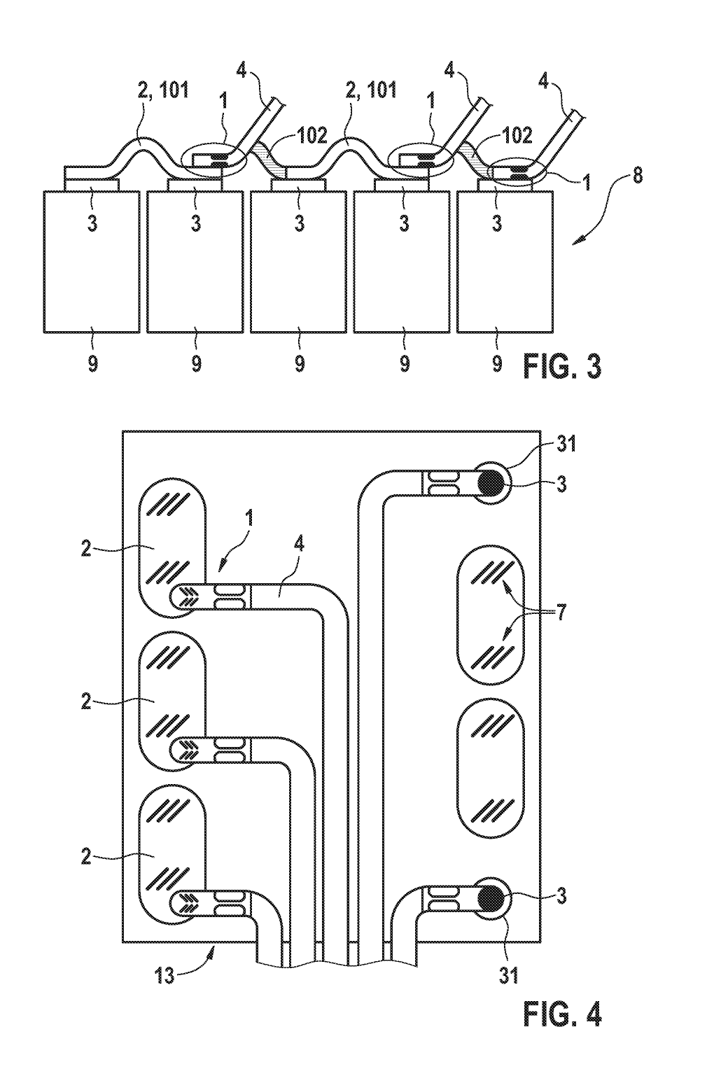

A representation of a battery module 8 having a plurality of battery cells 9 is shown schematically, in a side view, in FIG. 3. The battery cells 9 each have voltage taps 3. The voltage taps 3 of two battery cells 9 are connected to each other in an electrically conductive manner by means of a cell connector 2. The battery cells 9 each have two voltage taps 3, the representation according to FIG. 3 showing in each case only the front voltage tap 3 that faces toward the plane of the drawing, and not showing the rear voltage tap 3 that faces away from the plane of the drawing. The battery cells 9 shown in FIG. 3 are interconnected serially to each other, the front voltage taps 3 being connected to each other in an electrically conductive manner by non-hatched cell connectors 2, 101, and the rear voltage taps 3, which are not visible in the figure, being connected to each other in an electrically conductive manner by the hatched cell connectors 2, 102.

Furthermore, as described above, a connecting element 1 in each case connects a signal line 4 to the cell connector 2, 101 or 2, 102 in an electrically conductive manner and also mechanically. Furthermore, a connecting element 1 also connects a voltage tap 3 to the signal line 4 of a monitoring system of the battery module 8 in an electrically conductive manner and also mechanically, the battery cell 9 having such a connection, at the far right in the figure.

FIG. 4 shows a top view of a battery module 8 having a contacting system 13.

The contacting system 13 has a plurality of cell connectors 2, which connect the voltage taps 3 of two battery cells 9 to each other in an electrically conductive manner. For this purpose, the cell connectors 2 are each connected to the voltage taps 3 of the battery cells 9, in particular by welding, this being indicated here by weld points 7.

Furthermore, the contacting system 13 has openings 31, through which the voltage tap 3 of a battery cell 9 of the battery module 8 can be routed. In particular, the entire voltage of the battery module 8 can be tapped at the voltage taps 3 routed through the opening 31.

As can be seen from FIG. 4, a connecting element 1 in each case connects at least one conductor 5 of the signal lines 4 to a cell connector 2 or to the voltage tap 3 of a battery cell 9 in an electrically conductive manner.

1. A connecting element of a battery module or of a contacting system for a battery module,
the connecting element being configured to connect a cell connector, to at least one conductor of a signal line of a monitoring system of the battery module in an electrically conductive manner, wherein the cell connector is configured for electrically conductive connection of voltage taps of two battery cells of the battery module, or a voltage tap of a battery cell of the battery module,
the connecting element having a first connection region for materially bonded connection to the cell connector or to the voltage tap, and
the connecting element furthermore having a second connection region configured to accommodate at least one conductor of the signal line of the monitoring system of the battery module in a force-fitting and/or form-fitting manner.

2. The connecting element according to claim 1, characterized in that the connecting element comprises at least one electrically conductive material, such that the first connection region and the second connection region are connected to each other in an electrically conductive manner.

3. The connecting element according to claim 1, characterized in that the first connection region is connectable to the cell connector or to the voltage tap by welding, ultrasonic welding, soldering or adhesive bonding.

4. The connecting element according to claim 1, characterized in that the second connection region is deformable such that the second connection region can accommodate at least one conductor of the signal line in a force-fitting and/or form-fitting manner.

5. The connecting element according to claim 4, characterized in that the second connection region has at least one deformation region made of a metallic material, which is irreversibly deformable, such that the second connection region can accommodate at least one conductor of the signal line, such that the deformation region surrounds the at least one conductor in an at least partially contacting manner.

6. A contacting system for a battery module,
the battery module comprising a plurality of battery cells, which each have at least one voltage tap, and
the contacting system having at least one cell connector configured to connect the voltage taps of two battery cells of the battery module in an electrically conductive manner, and
the contacting system having at least one signal line, having at least one conductor configured for electrically conductive connection between one of the cell connector and the voltage tap, and a monitoring system,
the at least one cell connector and the at least one signal line being disposed on a support element,
wherein the contacting system has a connecting element according to claim 1.

7. The contacting system according to claim 6, characterized in that the connecting element connects the cell connector and the at least one conductor of the signal line to each other in an electrically conductive manner, the first connection region being connected to the cell connector in a materially bonded manner, and the second connection region accommodating the at least one conductor in a force-fitting and/or form-fitting manner.

8. A method for producing a contacting system, the method comprising
in a first step, providing a connecting element according to claim 1,
in a second step, positioning at least one cell connector and at least one signal line on a support element and,
in a third step, positioning the connecting element on the support element.

9. The method according to claim 8, wherein
in the third step, the first connection region is connected to the cell connector in a materially bonded manner.

10. A method for producing a battery module, the method comprising
in a first step, providing a connecting element according to claim 1,
in a second step, connecting the voltage taps of two battery cells to each other in an electrically conductive manner with at least one cell connector, and providing a signal line that is connectable to a monitoring unit, and
in a third step, connecting the first connection region to the cell connector in a materially bonded manner.

11. (canceled)

12. Battery module having a connecting element according to claim 1.

13. The connecting element according to claim 1, characterized in that the connecting element comprises copper, aluminum or nickel, such that the first connection region and the second connection region are connected to each other in an electrically conductive manner.

14. The connecting element according to claim 1, characterized in that the second connection region is deformable such that the second connection region can accommodate at least one conductor of the signal line by crimping.

15. The contacting system according to claim 6, wherein the at least one cell connector and the at least one signal line are connected to the support element.

16. The method according to claim 8, wherein
in the third step, at least one conductor of the at least one signal line is accommodated by the second connection region.

17. The method according to claim 16, wherein
in the third step, the first connection region is connected to the cell connector in a materially bonded manner.

18. A method for producing a battery module, the method comprising
in a first step, providing a connecting element according to claim 1,
in a second step, connecting the voltage taps of two battery cells to each other in an electrically conductive manner with at least one cell connector, and providing a signal line that is connectable to a monitoring unit, and
in a third step, accommodating at least one conductor of the at least one signal line by the second connection region in a force-fitting and/or form-fitting manner.

19. The method according to claim 18, wherein, in the third step, the first connection region is connected to the cell connector in a materially bonded manner.
